(19) United States
(12) Patent Application Publication
(10) Pub. No.: US 2022/0154739 A1
(43) Pub. Date: May 19, 2022

(54) PISTON ROD UNIT, HYDRAULIC CYLINDER AND ARTICULATED BOOM

(71) Applicant: Schwing GmbH, Herne (DE)

(72) Inventors: Dirk Willing, Ahaus (DE); Mykola Oleksyuk, Hattingen (DE)

(21) Appl. No.: 17/599,739

(22) PCT Filed: Mar. 31, 2020
(86) PCT No.: PCT/EP2020/059134

§ 371 Date: Sep. 29, 2021

(30) Foreign Application Priority Data
Apr. 1, 2019 (DE) 10 2019 108 451.2

(51) Int. Cl. F15B 15/14; E04G 21/04; F16J 1/12; F16J 7/00

(52) U.S. Cl. CPC F15B 15/1457; E04G 21/0436; F16J 7/00; F16J 1/12; E04G 21/0445

(57) ABSTRACT

A piston-rod unit for a hydraulic cylinder including a first end piece that is a piston-side end piece and a second end piece that is a rod-eye-side end piece. The piston-rod unit also includes a hollow piston rod with a cavity and that is arranged between the first end piece and the second end piece. The cavity extends at least partially into one or both of the first end piece and the second end piece. A plug is inserted into the cavity such that the plug supports the piston rod and/or the first end piece or second end piece.

The invention relates to a piston-rod unit for a hydraulic cylinder, comprising at least one piston-side end piece and at least one rod-eye-side end piece, a hollow piston rod which is arranged between the end pieces, wherein a cavity is formed in the piston rod extending at least into at least one of the end pieces, and to a hydraulic cylinder having such a piston-rod unit, and to an articulated boom of a large manipulator having such a hydraulic cylinder.

Such a piston-rod unit is known from DE 10 2013 008 351 B3 or EP 1 346 157 B1. To reduce the weight of the hydraulic cylinders, the piston rods are nowadays usually bored hollow, especially in hydraulic cylinders on placing booms of truck-mounted concrete pumps. The remaining wall thickness of the hollow piston rods is designed in such a way that the required tensile and compressive forces can be transmitted by the piston rod. In particular, the connection area between the hollow piston rod and the rod-eye-side end piece with the pin receptacle for connecting the piston rod to a boom segment of the articulated boom is a critical area here, as the rod-eye-sided end deforms under the very high tensile and compressive forces to be transmitted and this deformation is also transmitted to the connection area with the hollow piston rod. This initially leads to elastic deformation of the hollow piston rod in the connection area, this deformation being reflected in particular in a change in the cross section of the hollow piston rod. In the event of continuous overstressing, it cannot be excluded that overload phenomena such as cracks will occur in the transition area between the hollow piston rod and the end piece and that the entire piston rod needs to be replaced.

Increasing the wall thickness in the connection area to prevent over excertion of the hollow connection area would be the closest solution, but this would increase the weight of the piston-rod unit, although this increased wall thickness would not be necessary for the actual transmission of the tensile and compressive forces. In addition to the weight requirements, the possibilities for reinforcing the connection area are also limited due to the available installation space.

It is therefore the task of the invention to specify an improved piston-rod unit which allows the hollow piston rod to be reinforced without significantly increasing the weight of the entire unit. In particular, load-induced elastic deformations of the piston rod and the end pieces are to be reduced. In particular, a lightweight hydraulic cylinder and an articulated boom with reduced weight are to be specified.

This task is solved by a piston-rod unit with the features of claim 1 as well as a hydraulic cylinder according to claim 13 and an articulated boom according to claim 14.

By inserting a plug into the cavity to support the piston rod and/or the end piece on the cavity side, it is possible to easily reinforce the hollow piston rod without significantly increasing the weight of the entire piston-rod unit. Thus, to reinforce the hollow piston rod, a plug is simply inserted into the cavity formed in the piston rod. Also the end piece into which the cavity formed in the piston rod extends, can also be supported on the cavity side by inserting the plug and thus be reinforced. This reinforcement has the effect of minimizing or virtually eliminating the elastic deformation of the hollow piston rod that occurs, for example, in the connection area between the end piece and the piston rod, and fatigue damages can thus be prevented. With the plug, a punctual reinforcement of the piston-rod unit can be achieved in a simple manner in that the piston rod and/or the end piece are supported on the cavity side by the plug inserted into the cavity.

Advantageous embodiments and further developments of the invention result from the dependent claims. It should be noted that the features listed individually in the claims can also be combined with one another in any desired and technologically useful manner and thus reveal further embodiments of the invention.

According to an advantageous embodiment of the invention, it is provided that the plug supports the piston rod in a connection area with the end piece through which the cavity extends. By supporting the connection area with the plug inserted in the cavity, a punctual reinforcement of the connection area can be achieved, in which elastic deformations are particularly critical, since they lead to cracks more quickly here. The support on the plug stabilizes the connection area between the hollow piston rod and the end piece against elastic deformation.

Particularly preferred is an embodiment that provides that the wall thickness of the piston rod in the connection area supported by the plug is the same as in the other areas of the piston rod penetrated by the cavity. With the same wall thickness of the piston rod both in the connection area supported by the plug and in the other areas of the piston rod penetrated by the cavity, the weight of the piston-rod unit can be effectively reduced, with the selective reinforcement in the connection area supported by the plug being sufficient to reduce elastic deformations of the piston-rod unit to such an extent that these do not lead to fatigue damages.

A particularly advantageous embodiment of the invention relates to the fact that the plug is constructed in two parts, a first part of the plug being arranged in the connection area between the piston rod and the end piece and a second part of the plug being arranged in the end piece. By dividing the plug into at least two plug parts, individual areas of the piston-rod unit can be selectively supported on the cavity side. The first part of the plug is preferably used to support the connection area between the piston rod and the end piece, so that elastic deformations caused by load are prevented here. The second part of the plug, on the other hand, can be arranged in the end piece and here effectively prevent elastic deformations of the end piece by supporting it on the cavity side by the plug part.

A particularly advantageous embodiment of the invention provides that a welded joint is formed in the connection area between the piston rod and the end piece, the plug covering the area of the welded joint on the cavity side as viewed in the axial direction of the piston rod. By covering the area of the welded joint in the axial direction of the piston rod, elastic deformation of the welded joint between the piston rod and the end piece in the connection area can be effectively prevented by the support of the plug on the cavity side, so that no fatigue damages occur to the weld seam formed here.

An advantageous embodiment of the invention provides that the rod-eye-side end piece has two laterally projecting pipe sockets, the plug being arranged between the pipe sockets in the cavity formed herein. With the plug arranged between the two laterally projecting pipe sockets of the rod-eye-side end piece, an effective reinforcement can be achieved which reduces deformation of the rod-eye-side end piece. With a reduction of the deformation in the laterally projecting tube sockets of the rod-eye-side end piece, the further deformations of the hollow piston rod are also minimized, since fewer deformations are transmitted from the end piece to the connected piston rod.

A particularly advantageous embodiment is one in which the plug has a through bore through which a hinge pin is guided at the rod-eye-side end piece. By passing the hinge pin through the plug, effective guidance of the hinge pin can be achieved at the rod-eye-side end piece, whereby on the one hand the deformations of the pin are minimized and on the other hand the plug is simply fixed in the rod-eye-side end piece.

An advantageous embodiment provides for the plug to be made of the same material as the piston rod, preferably steel. Since the hollow piston rod is only punctual reinforced by the plug, the use of a corresponding plug still results in a considerable weight advantage over a solid piston rod made of the same material. Preferably, the plug is made of steel, as this material has a high compressive strength.

According to a preferred embodiment of the invention, the plug is at least partially made of light metal, preferably aluminum. With the reinforcement of the piston-rod unit by a plug made of a light metal, a punctual support is possible without significantly increasing the weight of the piston-rod unit. Preferably, the plug is made of aluminum, as this material has a high compressive strength and a low specific weight. The specific weight of aluminum is about one third of the specific weight of steel, so that a very effective increase in rigidity is possible in highly stressed areas of the piston-rod unit, although the overall weight of the piston-rod unit is increased only insignificantly by the plug. The plug can also be made of another stiff material that has sufficient compressive strength.

A particularly advantageous embodiment is one that provides for at least one annular sealing element to effect a seal between the plug and an inner wall of the cavity. To prevent dirt from entering the rod-eye-side spherical plain bearing from the outside and to prevent grease from lubricating the spherical plain bearing pin from entering the hollow piston rod, annular sealing elements are provided between the plug and an inner wall of the cavity for sealing. The annular sealing elements can be received in grooves which are preferably turned into the plug. The sealing elements are preferably designed as O-rings.

An advantageous embodiment provides that the plug is screwed to the end piece comprising the cavity via a head-side screw connection. The plug can be easily fixed in the cavity in the end piece via the head-side screw connection. The head-side screw connection preferably comprises a retaining plate which is screwed to the plug on the head side and is fastened to the end piece via screw connections.

A particularly advantageous embodiment of the invention provides that the plug is supported on a shoulder formed in the cavity. By supporting the plug on a shoulder formed in the cavity, a simple fixing of the plug in the cavity can be achieved. The plug can be easily supported on the shoulder, thus providing cavity-side support for the piston rod and end piece at a fixed position in the cavity.

Furthermore, it is an object of the invention to provide a hydraulic cylinder with a piston-rod unit as described above and in more detail below. A hydraulic cylinder equipped with such a piston-rod unit has, in addition to a lower weight, a high load capacity, since the piston-rod unit, which is punctually reinforced with the plug, can absorb greater forces without its weight being significantly increased by the plug.

Furthermore, it is an object of the invention to provide an articulated boom of a large manipulator, in particular of a truck-mounted concrete pump, with a plurality of boom segments, wherein the boom segments are each pivotable at articulated joints about articulation axes relative to an adjacent boom segment or a turntable, wherein at least one hydraulic cylinder, described in more detail as before and below, effects a pivoting movement in at least one articulated joint.

The demands on the boom length, i.e. on the reach of the articulated booms of large manipulators such as truck-mounted concrete pumps, are constantly growing. To keep the dead weight of the articulated booms as low as possible overall, particularly lightweight hydraulic cylinders are advantageous. The use of lightweight hydraulic cylinders saves own weight on the articulated booms, so that higher operating distances are possible.

Further features, details and advantages of the invention will be apparent from the following description and from the drawings, which show examples of embodiments of the invention. Corresponding objects or elements are provided with the same reference signs in all figures. Showing:

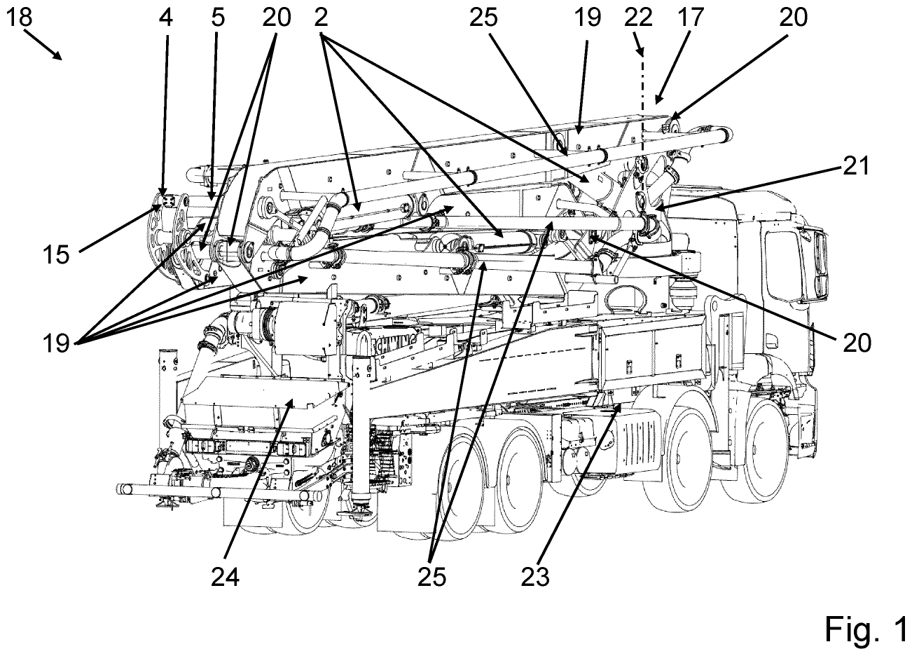

FIG. 1: Large manipulator with articulated boom according to the invention,

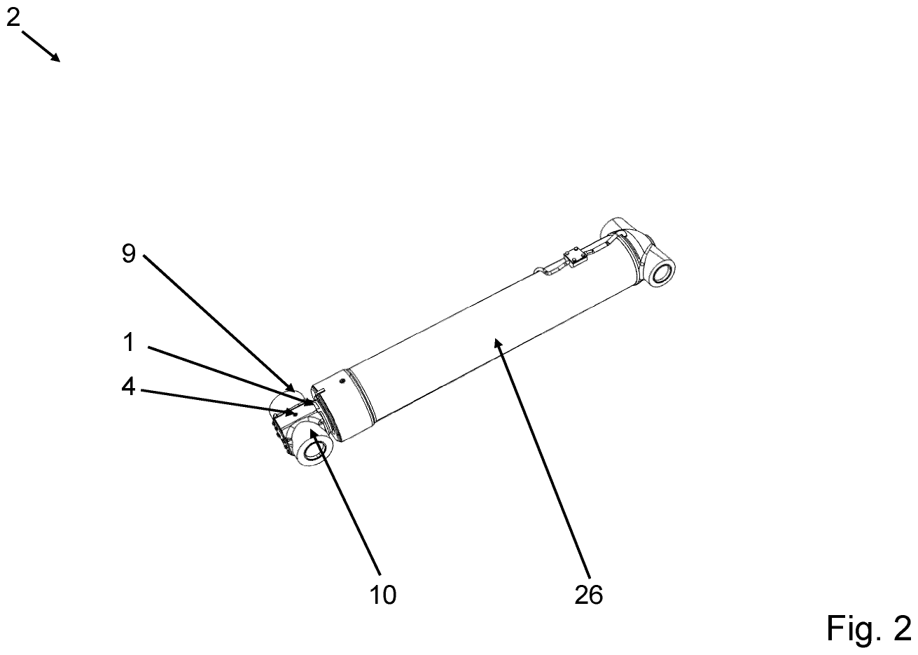

FIG. 2: Hydraulic cylinder according to the invention,

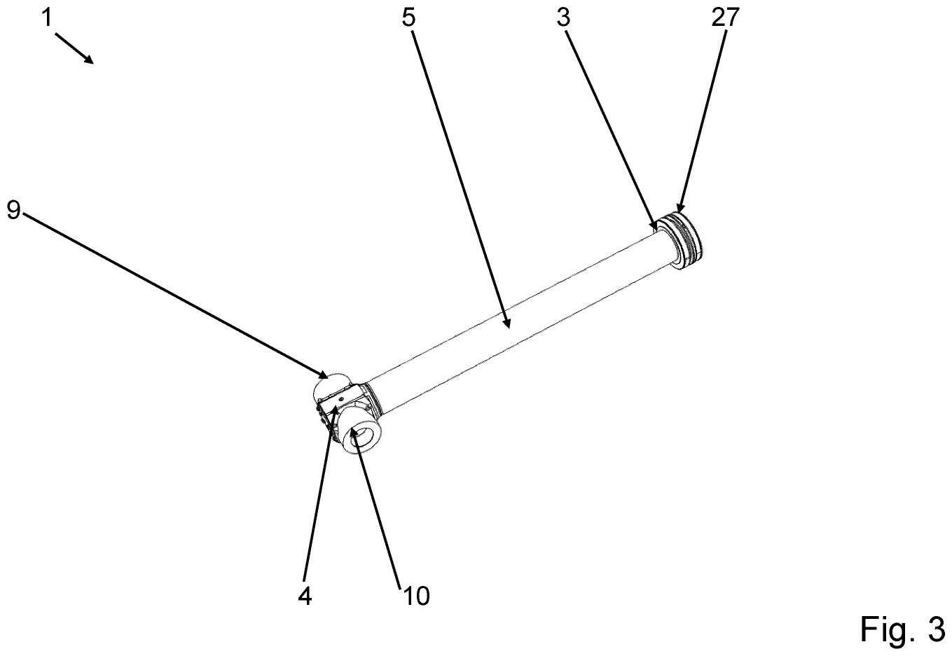

FIG. 3: piston-rod unit according to the invention,

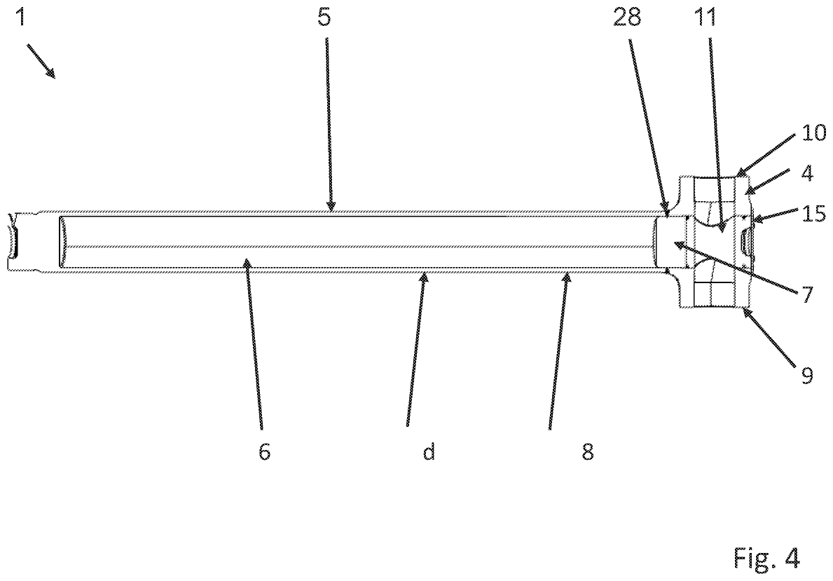

FIG. 4: Sectional view of the piston rod unit,

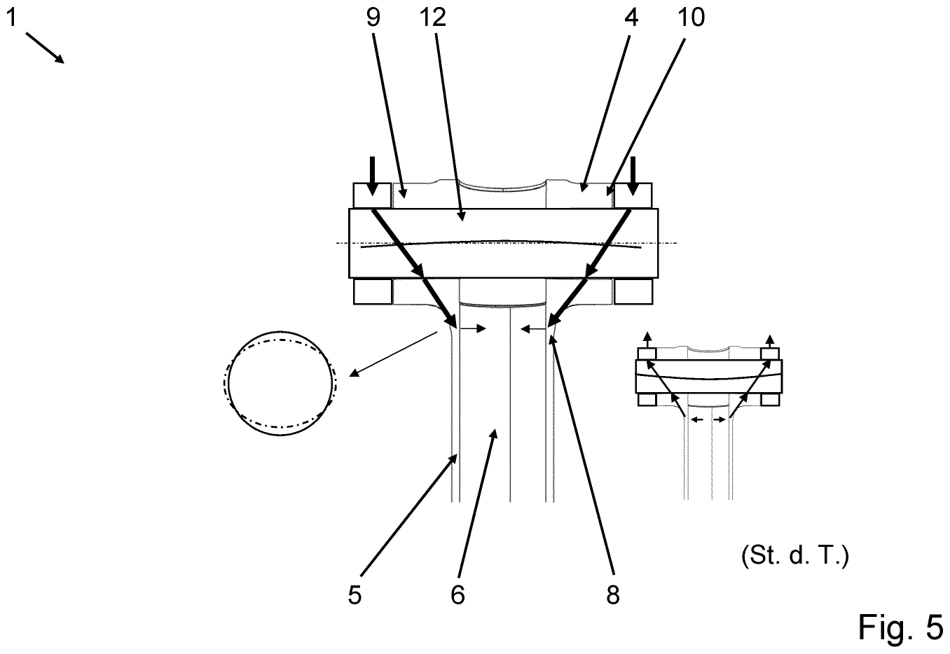

FIG. 5: Detailed sectional view under compressive load on a piston-rod unit according to the state of the art,

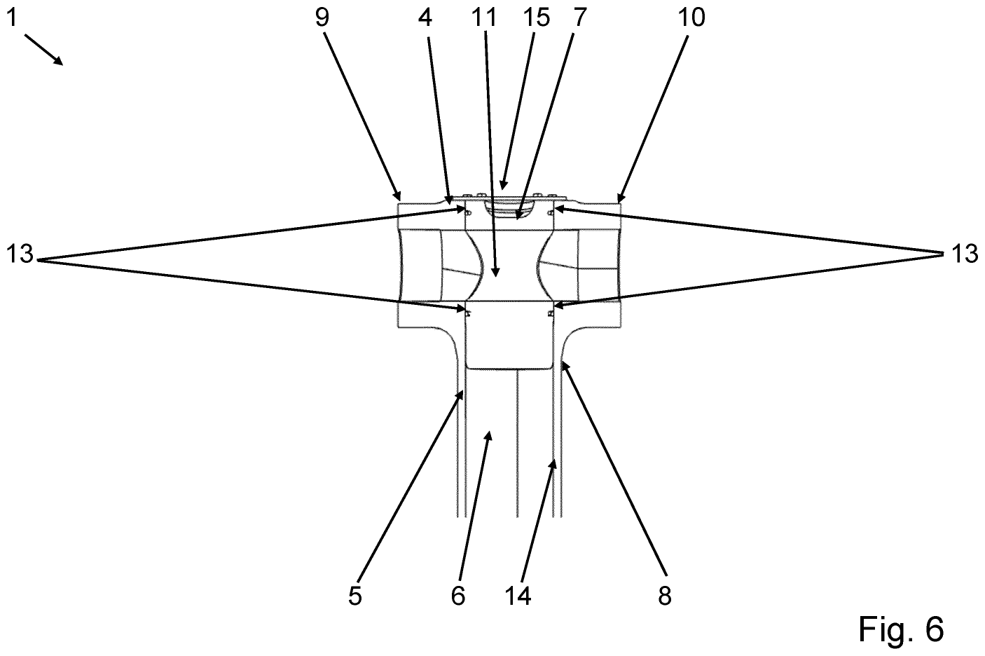

FIG. 6: Detailed sectional view of a piston-rod unit according to the invention,

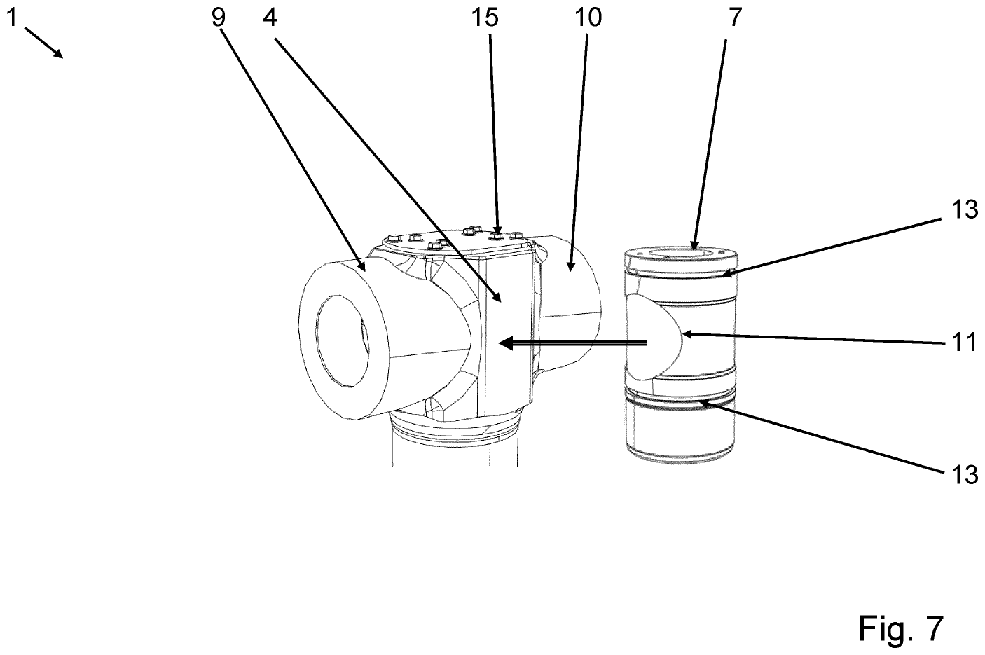

FIG. 7: Piston-rod unit with plug according to the invention and

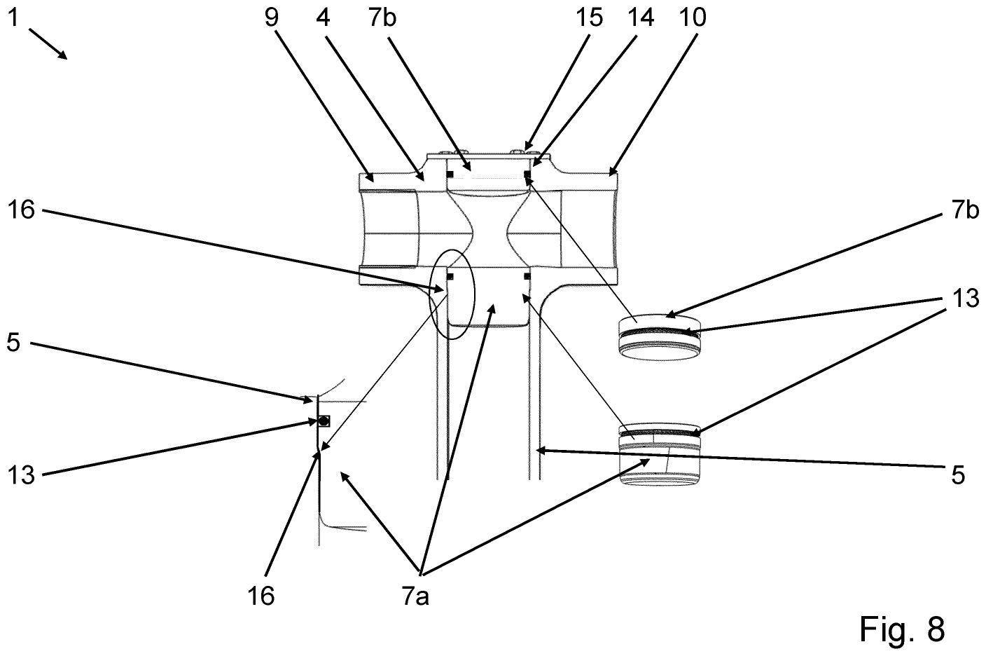

FIG. 8: Detailed sectional view of the piston-rod unit according to the invention with two-part plug.

In FIG. 1, the reference sign 17 indicates an articulated boom 17 according to the invention on a large manipulator 18 designed as a truck-mounted concrete pump. The articulated boom 17 is mounted on a turntable 21 rotatable about a vertical axis 22, which rotatably and pivotably supports the articulated boom 17 relative to the chassis 23 of the large manipulator 18 via an articulated joint 20. The articulated boom 17 has a plurality of boom segments 19, each of which can be pivoted in articulated joints 20 about axes of articulation relative to an adjacent boom segment 19 or to the turntable 21. To swivel the boom segments 19, hydraulic cylinders 2 are assigned to each of the articulated joints 20, which cause the boom segments 19 to swivel in the articulation axes. This pivoting movement can be used to unfold the articulated boom 17 shown folded in FIG. 1. In the unfolded state of the articulated boom 17, liquid concrete fed via the feed hopper 24 can be conveyed by means of a slurry pump unit in the truck-mounted concrete pump through the concrete delivery lines 25 arranged on the articulated boom 17 within the reach of the articulated boom 17 to the point of use on the construction site.

FIG. 2 shows a single view of a hydraulic cylinder 2 according to the invention, as it is associated with the articulated joints 20 of the articulated boom 17 in FIG. 1. In this single view, the piston-rod unit 1 is shown retracted into the cylinder body 26 of the hydraulic cylinder 2 so that only the rod-eye-side end piece 4 protrudes from the cylinder body 26.

FIG. 3 shows an individual view of the piston-rod unit 1 according to FIG. 2. This piston-rod unit 1 according to the invention has a piston-side end piece 3 on which a piston 27 is arranged. Furthermore, the piston-rod unit 1 has a rod-eye-side end piece 4. The rod-eye-side end piece 4 has two laterally projecting pipe sockets 9, 10. A hinge pin 12 (FIG. 5) is guided in these pipe sockets 9, 10 to connect the hydraulic cylinder 2 to a boom segment 19. The end pieces 3, 4 of the piston-rod unit 1 are connected to each other via a piston rod 5.

FIG. 4 shows a sectional view of the piston-rod unit 1 according to FIG. 3. This sectional view provides a view into the hollow piston rod 5 of the piston-rod unit 1. In this illustration, it can be clearly seen that the cavity 6 formed in the piston rod 5 extends at least into the rod-eye-side end piece 4. In the connection area 8 between the piston rod 5 and the end piece 4, a welded joint 28 is indicated, with which the piston rod 5 is connected to the end piece 4. The piston rod 5 has the same wall thickness d in the connection area 8 as in the other areas of the piston rod 5 penetrated by the cavity 6. As can be seen further in FIG. 4, the piston-rod unit 1 has a plug 7 which is inserted into the cavity 6 and supports the piston rod 5 and the rod-eye-side end piece 4 on the cavity side, i.e. from the inside. The plug 7 projects into the cavity 6 to such an extent that the connection area 8 of the piston rod 5 with the end piece 4 is supported by the plug 7. The plug 7 thus supports the connection area 8, in which the piston rod 5 has the same wall thickness d as in the other areas penetrated by the cavity 6. This permits selective reinforcement of the connection area 8 between the hollow piston rod 5 and the rod-eye side end piece 4 by the plug 7 inserted into the cavity 6. The selective reinforcement prevents in particular elastic deformations in the area of the welded joint 28 between the piston rod 5 and the end piece 4. For this purpose, the plug 7 covers the area of the welded joint 28 on the cavity side as seen in the axial direction of the piston rod 5. As can be seen further in FIG. 4, the plug 7 is arranged between the pipe sockets 9, 10 of the end piece 4 in the cavity 6 formed here. For forming the cavity 6 in the hollow piston rod 5 and for machining the welded joint 28 on the cavity side between the hollow piston rod 5 and the rod-eye-side end piece 4, the cavity 6 between the two pipe sockets 9, 10 of the end piece 4 is accessible. From this access, the plug 7 is inserted into the cavity 6. The cavity 6, respectively the hollow piston rod 5 and the end piece 4, can be turned or drilled smooth on the inside and the diameter of the plug 7 is preferably machined to fit, so that, the plug 7 can be inserted easily. In this way, the piston rod 5, or the connection area 8, is sufficiently stabilized from the inside, i.e. on the cavity side. The plug 7 is then screwed to the rod-eye-side end piece 4 via a head-side screw connection 15. In this way, the position of the plug 7 in the end piece 4 is fixed in a simple manner. The plug 6 can also be held in position by the hinge pin 12 alone. After loosening the screw connection 15, or removing the hinge pin 12, the plug 7 can simply be removed from the cavity 6 again. The plug 7 is thus also designed to be removable from the cavity 6. This means that the piston-rod unit 1 can also be checked for damage on/from the inside, i.e. on the cavity side, after prolonged operation of the hydraulic cylinder 2.

In addition, depending on the expected load, the piston-rod unit 1 can be manufactured with or without the plug 7, or the plug 7 can be easily installed later.

FIG. 5 shows a detailed sectional view of a piston-rod unit 1 according to the state of the art under compressive load on the hinge pin 12. The forces introduced by the hinge pin 12 into the end piece are indicated as vertical block arrows, which ultimately cause deformation of the hinge pin 12 and the end piece 4 with the protruding pipe sockets 9, 10. These deformations lead to a deformation of the hollow piston rod 5 in the connection area 8 between piston rod 5 and end piece 4, which is indicated by horizontally running arrows. The force curve during compressive loading is indicated by further block arrows running at an angle. When a tensile load is applied to the hinge pin 12 (indicated at the bottom right), the hinge pin 12 deforms in the opposite direction, resulting in a correspondingly opposite deformation of the end piece 4. This opposite deformation is also continued in the hollow piston rod 5 via the connection area 8. In the long term, the opposing deformations lead to material fatigue and, in the worst case, to fracture of the connection between end piece 4 and piston rod 5.

FIG. 6 shows a detailed sectional view through the piston-rod unit 1 according to the invention from FIG. 4. The plug 7 inserted in the cavity 6 is also shown in perspective in a single view in FIG. 7. In this single view, it is clearly visible that the plug 7 has a through bore 11 through which the hinge pin 12 (FIG. 5) is guided at the end piece 4 on the rod side. For this purpose, the plug 7 is inserted into the cavity 6, as shown in FIG. 6, in such a way that the through bore 11 is aligned with the laterally projecting pipe sockets 9, 10. The hinge pin 12 (FIG. 5) can be guided into this aligned arrangement at the rod-eye-side end piece 4. The aligned arrangement of the plug 7 is also ensured by the head-side screw connection 15 of the plug 7 to the rod-eye-side end piece 4. Annular sealing elements 13 are provided between the plug 7 and the inner wall 14 of the cavity 6, which provide a seal between the plug 7 and cavity wall 14. The first, upper sealing element 13 prevents dirt from entering the rod-eye-side spherical plain bearing from the outside. The second, lower sealing element 13 prevents grease from lubricating the hinge pin 12 (FIG. 5) from entering the hollow piston rod 5. The annular sealing elements 13 are arranged in grooves which are turned into the plug. The annular sealing elements 13 are o-rings.

FIG. 8 shows an embodiment in which the plug 7a, 7b is constructed in two parts. A first part 7a of the plug 7 is arranged in the connection area 8 between the piston rod 5 and the rod-eye-side end piece 4. The second part 7b of the plug 7 is arranged only in the end piece 4. The division of the plug 7 into the two plug parts 7a, 7b enables targeted cavity-side support of individual areas of the piston-rod unit 1. The first part 7a of the plug 7 supports the connection area 8 between the piston rod 5 and the rod-eye-side end piece 4 in such a way that load-induced elastic deformations, in particular due to compressive loads of the hinge pin 12 (FIG. 5), are prevented here. The second part 7b of the plug 7, on the other hand, by virtue of its arrangement in the end piece 4, effectively prevents elastic deformations of the end piece 4 in the event of tensile loads on the hinge pin 12 (FIG. 12), in that the latter is supported by the plug part 7b on the cavity side. The plug 7 or the plug parts 7a, 7b are not frictionally connected to the hollow piston rod 5, which means in particular that it is not envisaged that the plug 7, 7a, 7b itself transmits tensile forces. As before, the tensile forces are transmitted only via the hollow piston rod 5. FIG. 8 also shows a small shoulder 16 formed in the cavity 6 and supporting the lower plug part 7a. Through this, the lower plug part 7a is fixed in the hollow space 6 of the piston rod 5. The embodiment of the two-part plug 7a, 7b is particularly suitable for small hydraulic cylinders because the area of the pin passage does not have enough material for a through hole 11 (FIG. 7).

In addition to the shown support of the rod-eye-side end piece 4 and the connection area 8 between the rod-eye-side end piece 4 and the hollow-designed piston rod 5, the plug 7, 7a, 7b can also be used to support the piston-side end piece 3 and the connection area between the piston-side end piece 3 and the hollow-designed piston rod 5.

### LIST OF REFERENCE SIGNS

1 Piston-rod unit

2 Hydraulic cylinder

3 piston-side end piece

4 Rod-eye-side end piece

5 Piston rod

6 cavity

7 Plug, 7a, 7b plug parts

8 Connection area

9 First pipe socket

10 Second pipe socket

11 Through bore

12 Hinge pin

13 Sealing element

14 Interior wall

15 Head-side screw connection

16 Shoulder

17 Articulated boom

18 Large manipulator

19 Boom segment

20 Articulated joint

21 turntable

22 vertical axis

23 chassis

24 feed hopper

25 conveying line

26 cylinder body

27 piston

28 welded joint

d wall thickness

1-14. (canceled)

15. A piston-rod unit for a hydraulic cylinder comprising:
a first end piece that is a piston-side end piece;
a second end piece that is a rod-eye-side end piece;
a hollow piston rod including a cavity and arranged between the first end piece and the second end piece, wherein the cavity extends at least partially into one of or both of the first end piece and the second end piece; and
a plug inserted into the cavity such that the plug supports the piston rod and/or either the first end piece or the second end piece.

16. The piston-rod unit of claim 15, wherein a welded joint is formed in a connection area between the piston rod and either the first end piece or the second end piece, wherein the plug is arranged to extend along an axial direction of the piston rod in the cavity along an area of the welded joint.

17. The piston-rod unit of claim 15, wherein the second end piece has two laterally projecting pipe sockets, wherein the plug is arranged between the two pipe sockets in the cavity.

18. The piston-rod unit of claim 15, wherein the plug supports the piston rod in a connection area with either the first end piece or the second end piece through which the cavity extends.

19. The piston-rod unit of claim 18, wherein a wall thickness of the piston rod in the connection area supported by the plug is the same as in other areas of the piston rod through which the cavity extends.

20. The piston-rod unit of claim 18, wherein the plug includes a first part and a second part, the first part of the plug is arranged in the connection area, the second part of the plug is arranged in either the first end piece or the second end piece.

21. The piston-rod unit of claim 15, wherein the plug has a through bore through which a hinge pin extends at the second end piece.

22. The piston-rod unit of claim 15, wherein the plug comprises the same material as the piston rod.

23. The piston-rod unit of claim 22, wherein the material comprises steel.

24. The piston-rod unit of claim 15, wherein the plug comprises a light metal.

25. The piston-rod unit of claim 24, wherein the light metal is aluminum.

26. The piston-rod unit of claim 15, wherein an annular seal effects a seal between the plug and an inner wall of the cavity.

27. The piston-rod unit of claim 15, wherein the plug is screwed via a head-side screw connection to either the first end piece or the second end piece comprising the cavity.

28. The piston-rod unit of claim 15, wherein the plug is supported on a shoulder formed in the cavity.

29. A hydraulic cylinder comprising:
a piston-rod unit including:
a first end piece that is a piston-side end piece,
a second end piece that is a rod-eye-side end piece,
a hollow piston rod including a cavity and arranged between the first end piece and the second end piece, wherein the cavity extends at least partially into one of or both of the first end piece and the second end piece, and
a plug inserted into the cavity such that the plug supports the piston rod and/or either the first end piece or the second end piece.

30. An articulated boom comprising:
a plurality of boom segments each pivotable at articulated joints about articulation axes relative to an adjacent boom segment or a turntable; and
a hydraulic cylinder configured to effect a pivoting movement in at least one articulated joint, wherein the hydraulic cylinder includes:
a piston-rod unit including:
a first end piece that is a piston-side end piece,
a second end piece that is a rod-eye-side end piece,
a hollow piston rod including a cavity and arranged between the first end piece and the second end piece, wherein the cavity extends at least partially into one of or both of the first end piece and the second end piece, and
a plug inserted into the cavity such that the plug supports the piston rod and/or either the first end piece or the second end piece.
